(19) United States
(12) Patent Application Publication
(10) Pub. No.: US 2014/0250152 A1
(43) Pub. Date: Sep. 4, 2014

(54) Method, Device, Program Product, and Server for Generating Electronic Document Container Data File

(71) Applicant: SKYCOM Corporation, Tokyo (JP)

(72) Inventor: Tsutomu Kaneyasu, Tokyo (JP)

(73) Assignee: SKYCOM Corporation, Tokyo (JP)

(21) Appl. No.: 13/972,910

(22) Filed: Aug. 22, 2013

(30) Foreign Application Priority Data
Mar. 1, 2013 (JP) 2013-041185

(51) Int. Cl. G06F 17/30

(52) U.S. Cl. CPC G06F 17/30017
USPC 707/803

(57) ABSTRACT

An electronic-document-container-data-file generating method for generating a data file using a computer where the data file is to be read by a playback program operating on a computer includes: acquiring at least electronic document data as content data; generating editable memo data as content data, the memo data being associated with the acquired electronic document data; generating a container portion configured to hold a plurality of items of content data including the acquired electronic document data and the generated memo data; generating definition information for defining a method for playing back and/or a method for editing the plurality of items of content data during playback by the playback program; and generating an electronic-document-container data file including the generated container portion and the generated definition information.

### BACKGROUND OF THE INVENTION

1. Technical Field

This disclosure relates to a method, a device, and a program for generating an electronic-document-container data file, and a server device for delivering this data file on a network.

2. Description of the Related Art

Various technologies related to technology for playing back content files on a computer have been disclosed to date. For example, slide-show presentation technologies and musical effect technologies are known. In slide-show presentation technologies, a plurality of image data items are included in one file. A computer plays back each item of the image data at a predetermined time interval on a display. The musical effect technology acquires voice data during playback of music so as to generate graphical images, and displays the graphical images simultaneously with the playing back of music. In addition, playback preprocessing technologies have also been disclosed. In one example, Japanese Unexamined Patent Application Publication No. 2012-18657 (hereinafter referred to as Patent Literature 1) discloses technology related to an information processing device. The information processing device automatically determines whether an application selected by a user has been upgraded (updated). In the case where the determination result indicates that the application has not been upgraded, the information processing device performs a process for upgrading the application. Use of this technique allows providing a new application or similar service without requiring any operation by the user.

However, with slide-show presentation technologies, the computer arbitrarily decides the playback order of a plurality of items of image content in one file, and plays back the image content. The playback order does not have a special meaning. This is because a file creator is assumed not to have any particular intention regarding the playback order. There is not a need for defining information related to a meaningful relationship between images. Sound-effect and similar technologies are ultimately processes performed on a single item of content included in a single file, not processes performed on a plurality of items of content such as sound and video that are provided in advance. That is, there is no intention for the sound and the video to reflect the intentions felt by the file creator. A typical combination of the plurality of items of content includes a combination of the content itself and memo data referred for the content.

Furthermore, the technology disclosed in Patent Literature 1 simply determines whether or not updating is required with respect to applications (data) having only a single item of version information. Therefore, this does not disclose any technique that determines whether or not an update is needed for simultaneously playing back a data file including a plurality of kinds of content data after recognizing a version relationship between respective pieces of the content data in the data file.

### BRIEF SUMMARY OF THE INVENTION

To solve the above-described problems, this disclosure provides an electronic-document-container-data-file generating method for generating a data file using a computer. The data file for is read by a playback program operating on a computer, the data-file generating method comprising steps of: acquiring at least electronic document data as content data; generating editable memo data as content data where the memo data is associated with the acquired electronic document data; generating a container portion configured to hold a plurality of items of content data including the acquired electronic document data and the generated memo data; generating definition information for defining a method for playing back and/or a method for editing the plurality of items of content data during playback by the playback program; and generating an electronic-document-container data file including the generated container portion and the generated definition information.

This disclosure further provides a device and a program for generating the data file, and a server device for delivering the program on a network.

This disclosure that mainly includes each configuration described above allows playing back a data file including various items of information without any inconvenience but with comfort.

### BRIEF DESCRIPTION OF THE SEVERAL VIEWS OF THE DRAWINGS

The foregoing and additional features and characteristics of this disclosure will become more apparent from the following detailed description considered with reference to the accompanying drawings, wherein:

FIG. 1 is a conceptual diagram illustrating an exemplary utilization form of an electronic-document-container data file generated by an electronic-document-container-data-file generating device in Embodiment 1;

FIG. 2 is a block diagram illustrating an exemplary function block of the electronic-document-container-data-file generating device in Embodiment 1;

FIG. 3 is a schematic diagram illustrating an exemplary configuration in the case where respective functional configurations of the electronic-document-container-data-file generating device in Embodiment 1 are achieved as hardware;

FIG. 4 is a flow chart illustrating an exemplary flow of a process in the electronic-document-container-data-file generating device of Embodiment 1;

FIG. 5 is a block diagram illustrating an exemplary function block of an electronic-document-container data file generated by an electronic-document-container-data-file generating device in Embodiment 1;

FIG. 6 is a block diagram illustrating an exemplary function block of an electronic-document-container data file in Embodiment 2;

FIG. 7 is a block diagram illustrating an exemplary function block of an electronic-document-container data file in Embodiment 3;

FIG. 8 is a block diagram illustrating another exemplary function block of the electronic-document-container-data-file generating device in Embodiment 1;

FIG. 9 is a block diagram illustrating another exemplary function block of the electronic-document-container data file generated by the electronic-document-container-data-file generating device in Embodiment 1;

FIG. 10 is a block diagram illustrating another exemplary function block of the electronic-document-container-data-file generating device in Embodiment 1; and

FIG. 11 is a block diagram illustrating another exemplary function block of the electronic-document-container-data-file generating device in Embodiment 1.

### DETAILED DESCRIPTION OF THE INVENTION

Hereinafter, each embodiment of this disclosure will be described by referring to the accompanying drawings. Mutual relationships between the embodiment and the claims are as follows. First, Embodiment 1 mainly corresponds to claims 1 to 7, 12 to 18, and similar claim. Embodiment 2 mainly corresponds to claim 8 and similar claim. Embodiment 3 mainly corresponds to claim 9, 10, and similar claim. Embodiment 4 mainly corresponds to claim 11 and similar claim. This disclosure is not limited to these embodiments. Various embodiments are possible without departing from the scope of this disclosure.

### Embodiment 1

### Electronic-Document-Container-Data-File Generating Device

### Outline

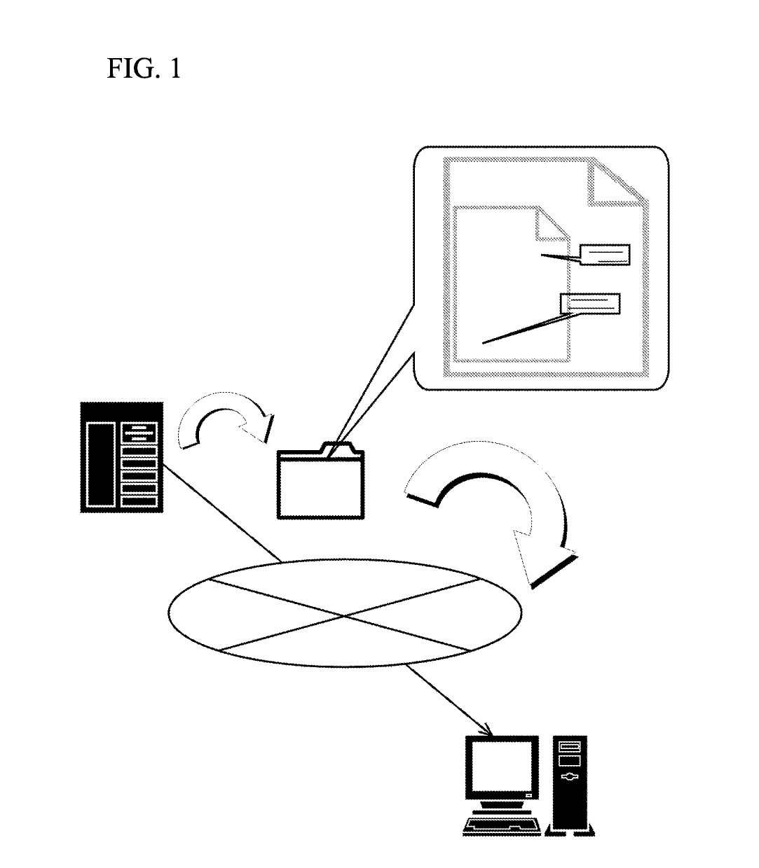

FIG. 1 is a conceptual diagram illustrating an exemplary utilization form of an electronic-document-container data file generated by an electronic-document-container-data-file generating device in this embodiment. As illustrated in this diagram, an electronic-document-container-data-file generating device in this embodiment is used for reading a data file by a playback program operating on a computer. The data file-generating device is configured to: acquire at least electronic document data as content data; generate editable memo data as content data where the memo data is associated with the acquired electronic document data; generate a container portion configured to hold a plurality of items of content data including the acquired electronic document data and the generated memo data; generate definition information for defining a method for playing back or/and a method for editing the plurality of items of content during playback by the playback program; and generate an electronic-document-container data file including the generated container portion and the generated definition information, as a feature.

### Functional Configuration

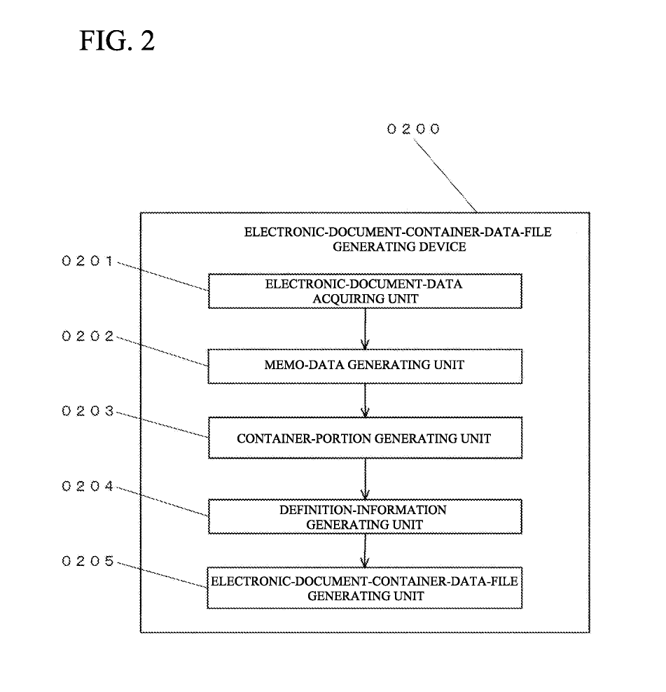

FIG. 2 is a block diagram illustrating an exemplary function block of the electronic-document-container-data-file generating device in this embodiment. As illustrated in this drawing, an electronic-document-container-data-file generating device 0200 of this embodiment includes an electronic-document-data acquiring unit 0201, a memo-data generating unit 0202, a container-portion generating unit 0203, a definition-information generating unit 0204, and an electronic-document-container-data-file generating unit 0205.

Respective function blocks of the electronic-document-container-data-file generating device described below can be achieved as hardware, software, or both hardware and software. Specifically, if a computer is used, the function blocks include, for example, a CPU, a main memory, a GPU, an image memory, a graphic board, a bus, a secondary storage unit (such as a hard disk, a non-volatile memory, a storage medium such as a CD and a DVD, and a drive for reading these media), an input device used for inputting information, a touchscreen, an electronic pen mainly used for touching a touchscreen, a scanner device, a printer, other external peripheral devices as a hardware configuration portion, and also include, for example, an interface for the external peripheral device, a communication interface, a driver program for controlling these hardware units, and other application programs. An arithmetic process by the CPU running the program loaded on the main memory processes and accumulates data and similar object that are input from input devices and other interfaces and then held on the memory and the hardware, and generates commands for controlling respective hardware and software units. Here, the above-described program may be achieved as a plurality of modularized programs or may be achieved as one program by combining two or more programs together.

A part of this device may be configured as software. A storage medium where this software is stored is obviously within the technical scope of this disclosure (this is not limited to this embodiment and is similar through the entire description). The electronic-document-container-data-file generating program may be held in a server device and delivered on a network so as to be used for ASP service and similar service.

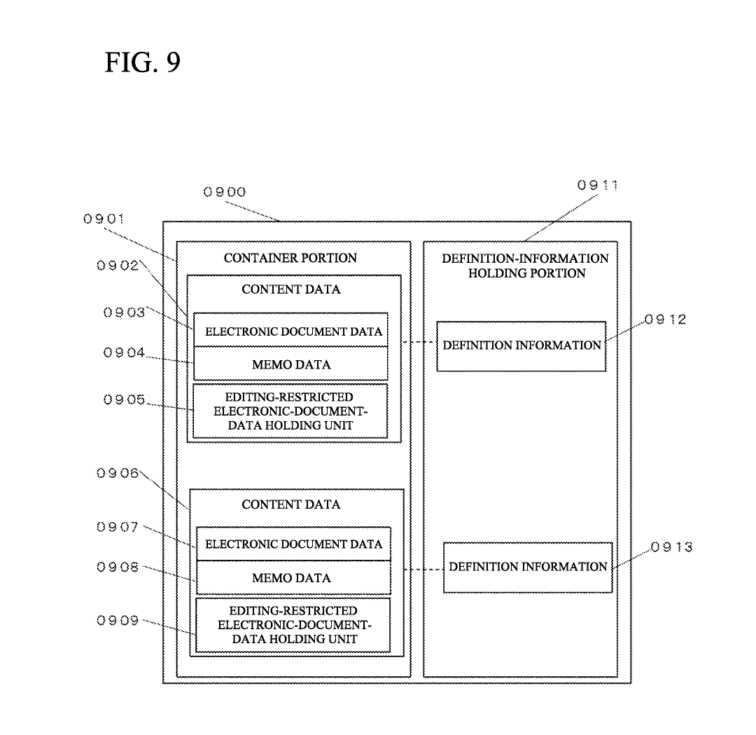

The electronic-document-data acquiring unit 0201 has a function for acquiring at least electronic document data as content data. Here, “content data” is assumed to be chart data, music data, image data, moving image data, program data, and similar data in addition to the electronic document data. The electronic document data is considered to employ a format (editing-restricted electronic-document-data holding units 0905 and 0909 illustrated in FIG. 9) where at least a part of the data has editing restrictions, for example, a portable document format (PDF, a file format compliant to ISO32000-1 of an international organization for standardization (ISO)). However, the format is not limited especially to this format. In the case where the content is a copyright work of another person, and a playback user does not have a right of editing or modification, the entire content has editing restrictions and includes memo data separately from the contents. This is especially convenient.

The memo-data generating unit 0202 has a function that generates editable memo data as the content data in association with the acquired electronic document data. Here, “editable memo data” indicates data of content that can be associated with the electronic document data, and is not limited to such electronic document data as so-called desktop notes. For example, in addition to the electronic document data, chart data, music data, image data, moving image data are possible. “Editable” means holding the memo data in a state that allows changing the content of the memo data even after the electronic-document-container data file is generated. This configuration makes possible the correcting of information to be associated with the content data by adding or taking away later, to render the content of the memo data meaningful for the user.

“Associated with the electronic document data” is considered to be performing, for example, a process that associates the electronic document data with the memo data and holds respective items of data separately. Additionally, performing a process that combines and holds the electronic document data and the corresponding memo data as one electronic document data is also considered.

The container-portion generating unit 0203 has a function for generating a container portion that holds a plurality of items of content data including the acquired electronic document data and the generated memo data. Here, “container” is considered to be a configuration that holds a plurality of different items of data with a specific format. However, this configuration may hold a plurality of different items of data with mixed formats. That is, for example, the configuration may hold a plurality of PDF data files and a plurality of items of memo data associated with the respective PDF data files, or may hold PDF data files, another electronic document data file, and a plurality of items of memo data associated with the respective data files.

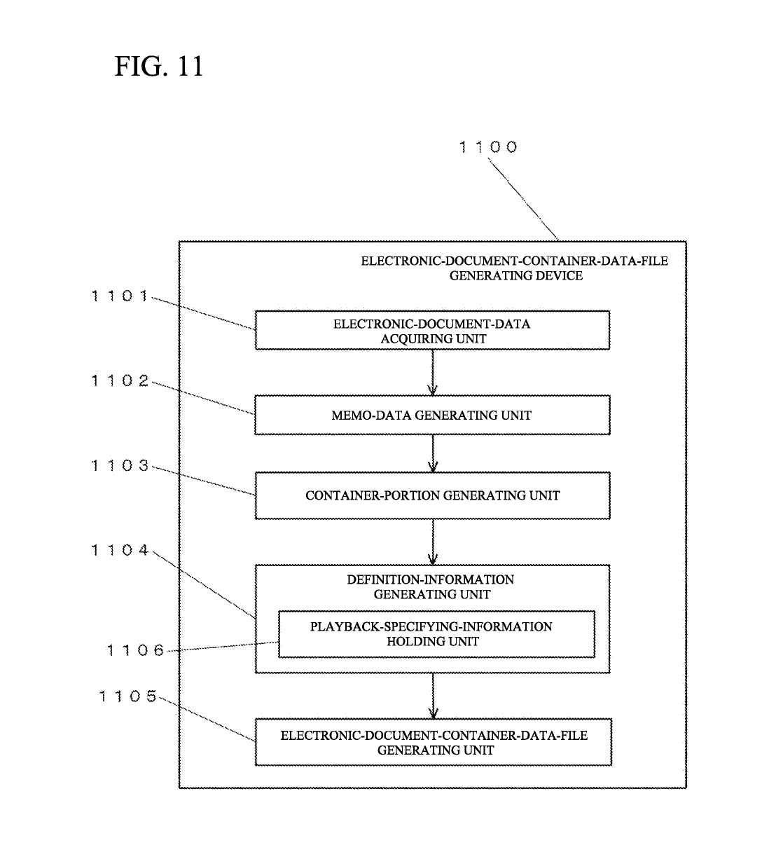

The definition-information generating unit 0204 has a function for generating definition information that defines a method for playing back or/and a method for editing the plurality of items of content data during playing back with a playback program. The definition information corresponding to one item of content data may have single item of information or a plurality of items of information. The “method for playing back the plurality of items of content data” includes, specifically, a playback order of the respective items of the content data (conceivably, deciding an order of the respective items of the content data corresponding to content names, created dates and times, updated dates and times, volumes of data sizes, and similar parameters), additionally, a content of how to play back the electronic document data and the memo data. That is, the “method for playing back the plurality of items of content data” here includes a playback order of the respective items of the content data, for example, whether the electronic document data and the memo data are played back simultaneously, and whether only the memo data is played back afterward by an operation of the user. The “method for playing back the plurality of items of content data” also includes a rule related to a layout, for example, what is used for display formats of respective items of the content data when both items of the content data are displayed and played back. Even more specifically, for example, an automatic playback interval between pages of the electronic document, information for specifying a playback page of another electronic document to be played back in association with a specific playback of one electronic document, information for specifying a playback area of another moving image as content to be played back in association with a specific playback page of one electronic document, information for specifying a playback area of another sound file as content to be played back in association with a specific playback page of one electronic document, and information for specifying a playback page of another electronic document to be played back after a specific playback page of one electronic document are considered as the method for playing back the content data. The configuration may employ a playback-specifying-information holding unit 1106 illustrated in FIG. 11 especially as a function for holding one or more items of the definition information among the respective items of definition information described above.

Conceivable as the “method for editing the content data” are rules related to changing the content of the content data, for example, whether writing onto the electronic document data and the memo data is permitted, whether during the write operation encryption is required, and specifying the encryption. The method for editing the content here includes a rule related to a process that upgrades or downgrades the version of the content data in the case where a version of the playback program and a version of the content data to be played back by the playback program do not have compatibility with each other. That is, for example, since the version of the content data is an older version than the version of the playback program or the version of the playback program is an older version than the version of the content data, the affinity between the respective versions needs to be checked and verified when the playback program is performed so as to avoid a situation where the content data is not accurately played back. The method for editing the content data as the definition information includes, as described above, rules related to checking and verifying the respective versions of the playback program and the content data, and rules related to a subsequent process for upgrading or downgrading the version.

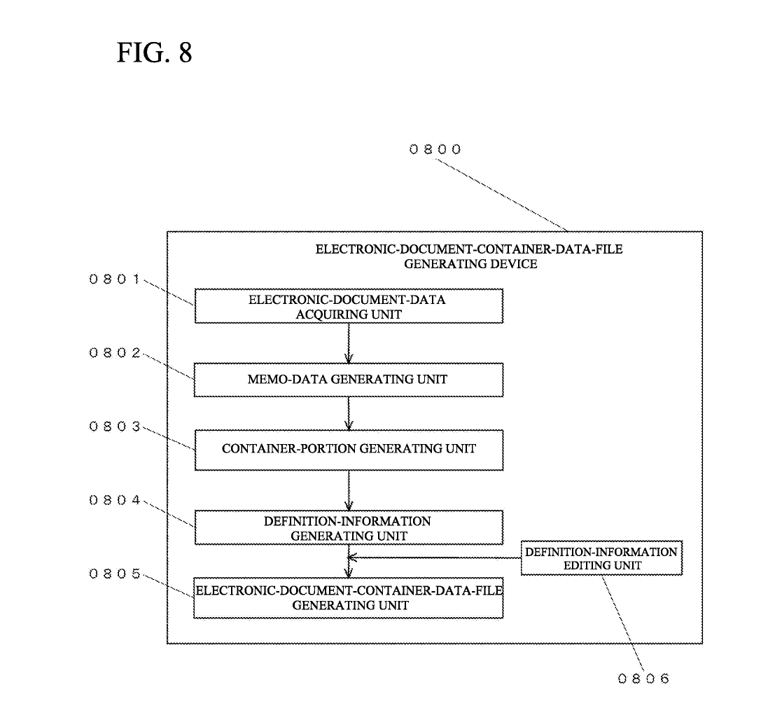

A function for editing a content of the definition information may be added. FIG. 8 is a block diagram illustrating another exemplary function block of the electronic-document-container-data-file generating device in this embodiment. As illustrated in this drawing, employing a configuration with a definition-information editing unit 0806 allows subsequently adding and removing definition information generated once and changing a content of generated definition information. Thus, enabling to edit the definition information allows providing an electronic-document-container data file usable in various situations.

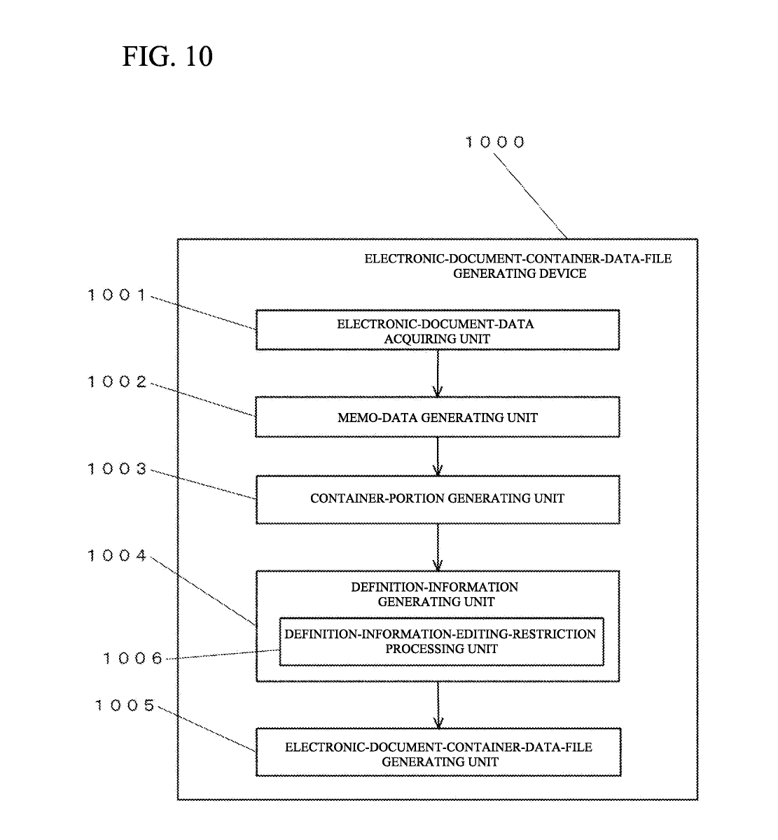

In contrast, a configuration that has a function for restricting editing of the definition information may be possible. FIG. 10 is a block diagram illustrating another exemplary function block of the electronic-document-container-data-file generating device in this embodiment. As illustrated in this drawing, employing a configuration with a definition-information-editing-restriction processing unit 1006 allows avoiding, for example, a situation where the definition information of the electronic-document-container data file is changed by a third person without permission.

The electronic-document-container-data-file generating unit 0205 has a function for generating an electronic-document-container data file that includes a generated container and generated definition information. The container and the definition information constituting one electronic-document-container data file allows smooth playback without noticing the configuration of the data, for example, the playback order and the difference in version in the case where the user desires to play back the data in the container.

### Specific Configuration

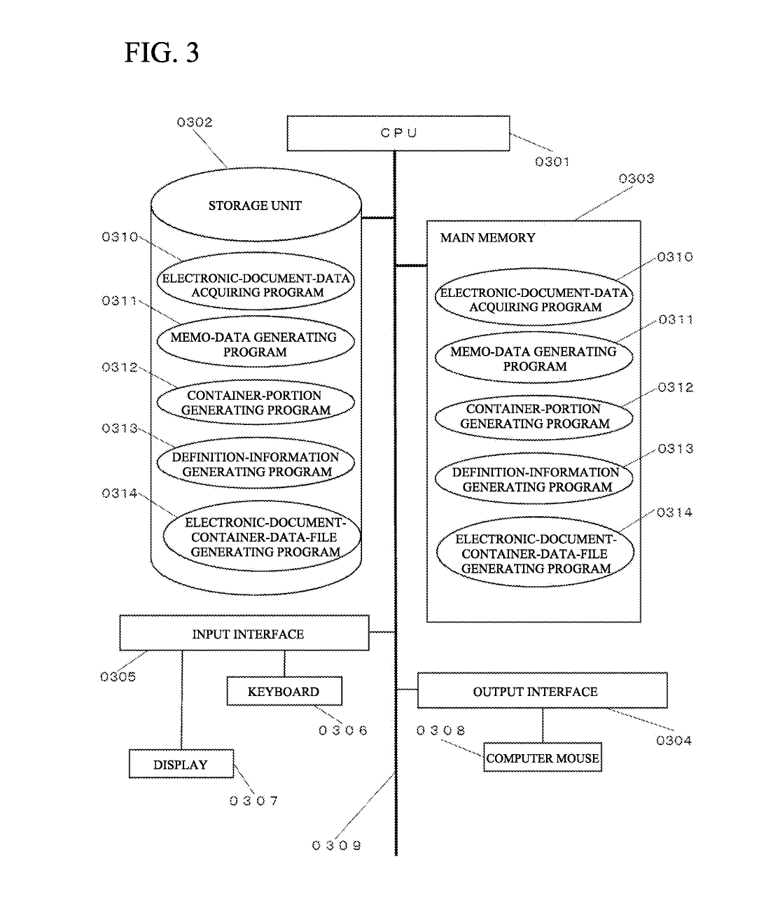

FIG. 3 is a schematic diagram illustrating an exemplary configuration in the case where respective functional configurations of the electronic-document-container-data-file generating device in this embodiment are achieved as hardware. This diagram is used to describe functions of respective hardware configuration units.

As illustrated in this diagram, the electronic-document-container-data-file generating device includes a CPU 0301 for performing various arithmetic processes, a storage unit (a storage medium) 0302, a main memory 0303, an output interface 0304, and an input interface 0305. The electronic-document-container-data-file generating device transmits and receives information from/to an external peripheral device such as a keyboard 0306, a computer mouse 0307, and a display 0308 through the input/output interfaces. Here, the storage unit 0302 stores various programs as described below. The CPU 0301 reads the various programs into a work area of the main memory 0303 and executes the programs. These configurations are coupled to one another through a data communication path such as a system bus 0309 to transmit and receive information and process of information.

### Specific Process in the Electronic-Document-Data Acquiring Unit

The CPU 0301 executes an electronic-document-data acquiring program 0310, acquires electronic document data corresponding to an input signal through the input interface 0305, and stores this data at a predetermined address in the main memory 0303.

### Specific Process of the Memo-Data Generating Unit

The CPU 0301 reads out the electronic document data and executes a memo-data generating program 0311, acquires memo data corresponding to an input signal through the input interface 0305, performs a process that associates this memo data with the read electronic document data, and stores a result of this process at a predetermined address in the main memory 0303.

### Specific Process of the Container-Portion Generating Unit

The CPU 0301 reads out a plurality of items of content data including the electronic document data and the memo data to execute a container-portion generating program 0312, and performs a process that generates a container portion for holding the electronic document data and the memo data. Here a process that stores both the items of data in the generated container portion may be executed.

### Specific Process in the Definition-Information Generating Unit

The CPU 0301 reads out a plurality of items of content data and executes a definition-information generating program 0313, performs a process for generating definition information that defines a method for playing back or/and a method for editing the content data, and stores a result of the process at a predetermined address in the main memory 0303.

### Specific Process of the Electronic-Document-Container-Data-File Generating Unit

The CPU 0301 reads out the container portion, which holds the content data, and the definition information to execute an electronic-document-container-data-file generating program 0314, performs a process that generates respective items of information as one electronic-document-container data file, and stores a result of this process at a predetermined address in the main memory 0303.

### Flow of the Process

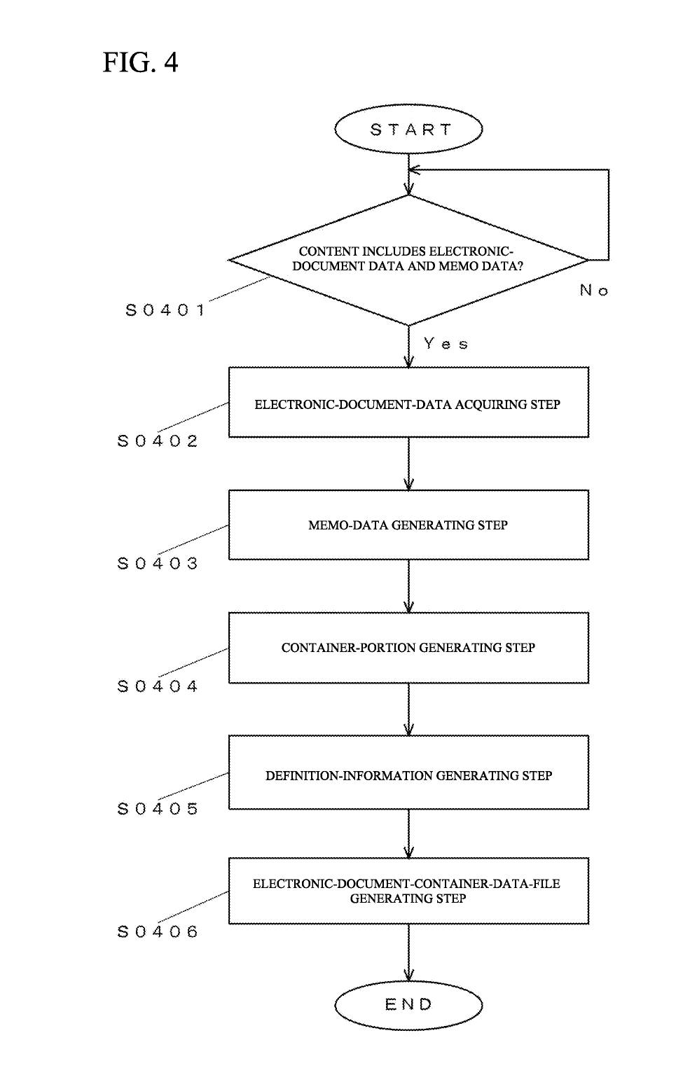

FIG. 4 is a flow chart illustrating an exemplary flow of a process in the electronic-document-container-data-file generating device of this embodiment. The flow of the process in this diagram includes the following steps. First, it is determined whether the content data, which has been received as an input, includes the electronic document data in step S0401. In the case where a determination result indicating that the electronic document data is not included is made, the process returns to step S0401. In the case where a determination result indicating that the electronic document data is included is made, the process proceeds to step S0402. In step S0402, acquisition of the content data as the electronic document data is received (an electronic-document-data acquiring step). In step S0403, the memo data is generated and a process that associates the generated memo data with specific electronic document data is performed (a memo-data generating step). Subsequently, in step S0404, a process that generates the container portion to hold a plurality of items of content data including the electronic document data and the memo data is performed (a container-portion generating step). In step S0405, definition information that defines a method for playing back or/and a method for editing the plurality of items content data is generated (a definition-information generating step). In step S0406, a process that generates an electronic-document-container data file including the container portion generated in the container-portion generating step and the definition information generated in the definition-information generating step (an electronic-document-container-data-file generating step).

### Electronic-Document-Container Data File

### Functional Configuration

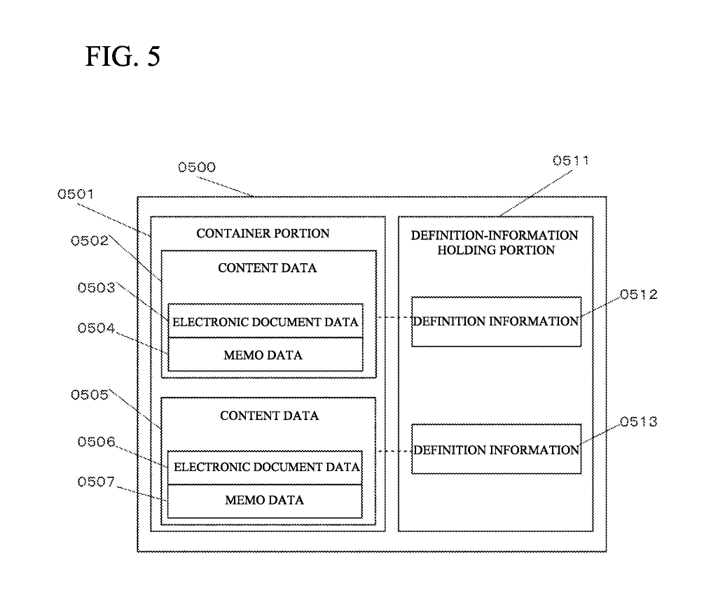

FIG. 5 is a block diagram illustrating an exemplary function block of an electronic-document-container data file that is generated by the electronic-document-container-data-file generating device in this embodiment and read by a playback program operating on a computer. As illustrated in this diagram, an electronic-document-container data file 0500 includes a container portion 0501 and a definition-information holding portion 0511. The container portion 0501 holds respective items of content data 0502 and 0505 where electronic document data 0503 and 0506 are associated with memo data 0504 and 0507. The definition-information holding portion 0511 holds respective items of definition information 0512 and 0513 associated with the content data 0502 and 0505. As illustrated in this diagram, the respective items of the content data and the definition information do not need to be associated with one another in a one-to-one relationship. For example, one item of definition information and a plurality of items of content data may be associated with one another. Here, specific functions of respective function blocks of the electronic-document-container data file 0500 are similar to the points already described in the respective portions as objects generated by the electronic-document-container-data-file generating device.

### Effects

Use of an electronic-document-container-data-file generating device for generating an electronic-document-container data file with the above-described configuration allows playing back the data file without particular disadvantage even in the case where respective versions of various items of content data are different from one another.

### Embodiment 2

### Electronic-Document-Container Data File

### Outline

An electronic-document-container data file generated by an electronic-document-container-data-file generating device in this embodiment is basically similar to the electronic-document-container data file in Embodiment 1. However, a container portion of the electronic-document-container data file in this embodiment holds bookmark data as an additional feature. The bookmark data specifies a browsing position in the electronic document data. This feature allows browsing without stress even when the electronic document data with a huge amount of information is used.

### Functional Configuration

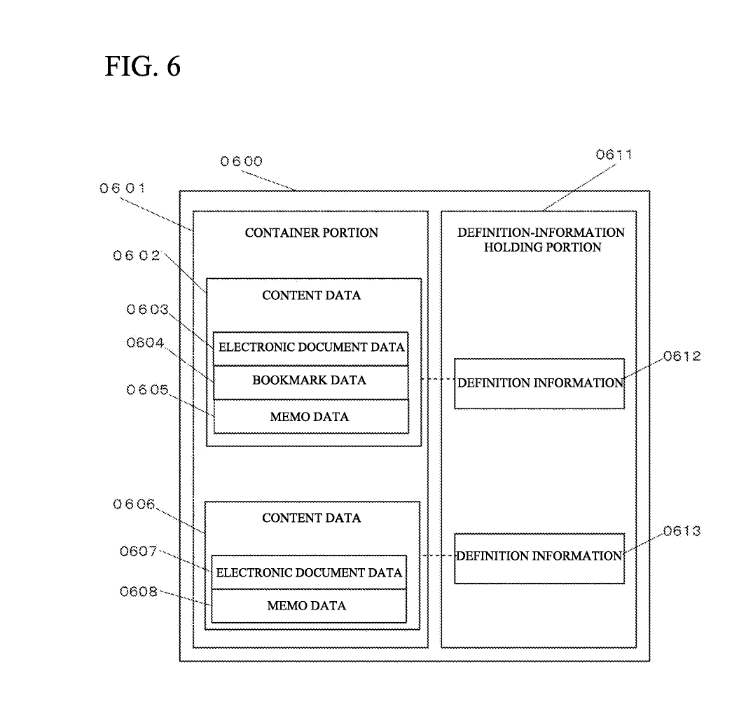

FIG. 6 is a block diagram illustrating an exemplary function block of the electronic-document-container data file in this embodiment. As illustrated in this diagram, an electronic-document-container data file 0600 in this embodiment includes a container portion 0601 and a definition-information holding portion 0611. The container portion 0601 holds respective items of content data 0602 and 0606 where electronic document data 0603 and 0607, bookmark data 0604, and memo data 0605 and 0608 are associated with one another. The definition-information holding portion 0611 holds respective items of definition information 0612 and 0613 associated with the content data 0602 and 0606. A basic configuration is in common with the electronic-document-container data file described using FIG. 5 in Embodiment 1. Therefore, the bookmark data 0604 that is a different configuration will be described below.

The bookmark data 0604 has a function that specifies a browsing position in the electronic document data. A method for specifying the browsing position is considered to be, for example, a method that performs a process for specifying a text in a predetermined range in the electronic document data, and considered also to be a method for specifying a specific position in the electronic document data as a browsing position. This configuration precisely specifies a portion desired by the user regardless of the format and the content of the electronic document data, and improves convenience when the user browses this part again later.

### Effects

The electronic-document-container data file 0600 with this configuration allows browsing information continuously from a previously browsed part without complicated work such as taking a note of an interruption position when the browsing is interrupted. This allows the user to restart browsing without stress even in the case where especially the electronic document data has a huge amount of information and it is difficult to browse the electronic document data at one time.

### Embodiment 3

### Electronic-Document-Container Data File

### Outline

An electronic-document-container data file generated by an electronic-document-container-data-file generating device in this embodiment is basically similar to the electronic-document-container data file in Embodiment 1 or 2. However, the electronic-document-container data file in this embodiment holds index data for searching within the content held in the container portion as a feature. In the case where the user desires that a specific portion is preferentially played back among the content data with a large amount of information regardless of a data type such as text data, moving image data, and music data, this feature allows precisely searching and playing back the specific portion corresponding to the desire of the user.

### Functional Configuration

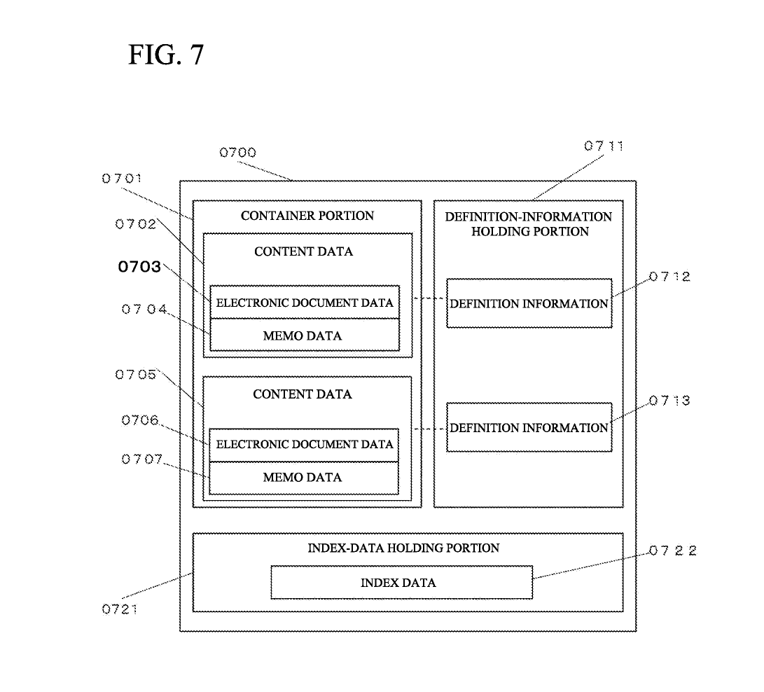

FIG. 7 is a block diagram illustrating an exemplary function block of an electronic-document-container data file in this embodiment. As illustrated in this diagram, an electronic-document-container data file 0700 in this embodiment includes a container portion 0701, a definition-information holding portion 0711, and an index-data holding portion 0721. The container portion 0701 holds respective items of content data 0702 and 0705 where electronic document data 0703 and 0706 and memo data 0704 and 0707 are associated with one another. The definition-information holding portion 0711 holds respective items of definition information 0712 and 0713 associated with the content data 0702 and 0705. The index-data holding portion 0721 holds index data 0722. A basic configuration is in common with the electronic-document-container data file described using FIG. 5 in Embodiment 1. Therefore, the index-data holding portion 0721 and index data 0722 that are different configurations will be described below.

The index-data holding portion 0721 has a function for holding the index data 0722. The index data is data for searching within the content held in the container portion 0701. Specifically, for example, in the case of text data, the index data is considered to be data that allows searching predetermined word, character string, and paragraph for example. In the case of moving image data and music data, the index data is considered to be data that allows searching based on data such as subtitles associated with time point where a predetermined time has been elapsed in entire playback time. A specific search method is considered to be a method that receives an input of any character from the user and displays character information with a content matched with this character as a search result, a method that preliminarily displays image data in thumbnailed form and receives a selection input of an image that indicates a playback position of a moving image desired by the user among the thumbnails so as to display a search result, and similar method.

Here, the index data is data for searching the content. Therefore, obviously in the case where a plurality of items of content data themselves in the container portion are deleted or newly acquired, and also in the case where the content of the content data is rewritten, the content of the index data needs to be changed. Accordingly, the index data is preferred to be updated in short cycles to allow always searching the latest content of the content data in the container portion.

### Effects

In the case where the user desires that a specific portion is preferentially played back among the content data with a large amount of information regardless of a data type such as text data, moving image data, and music data, the electronic-document-container data file 0700 with this configuration allows precisely searching and playing back the specific portion corresponding to the desire of the user.

### Embodiment 4

### Outline

An electronic-document-container data file generated by an electronic-document-container-data-file generating device in this embodiment is basically similar to the electronic-document-container data file in any one of Embodiments 1 to 3. However, in the case where the playback program is an electronic document reader, the electronic-document-container data file in this embodiment has a configuration that allows reading electronic document data in the container portion by reading with the playback program as a feature.

### Functional Configuration

The electronic-document-container data file in this embodiment has a basic configuration approximately similar to the basic configuration of the electronic-document-container data file described using FIG. 5 in Embodiment 1. Therefore, a process in the case where the playback program is an electronic document reader that is a different configuration will be described below.

The “case where the playback program is an electronic document reader” means that the playback program is an application for displaying and playing back electronic document data in a readable state. The electronic document data is considered to be, for example, a PDF data file, a data file in DOC format, a data file in Office Open XML Document format, and a data file in OpenDocument Text format. Usually, in the case where the vulnerability of the program is found, the electronic document reader for playing back these data files is upgraded to overcome the vulnerability as necessary. The upgraded program is provided to the user as a playback program with the latest version each time. Depending on a content of the upgrading, the latest playback program might not play back the old electronic document data. That is, in the case where a plurality of items of electronic document data are created, readable electronic document data and non-readable electronic document data by an electronic document reader exist depending on the creation times.

Here, the electronic-document-container data file of this disclosure includes the container portion including the electronic document data and the memo data as a configuration requirement. In the case where the memo data is electronic document data, the situation where creation times of both items of electronic document data are different from each other as described above may occur. Due to occurrence of this situation, in the case where one electronic document reader is started, mixing of the readable electronic document data and the non-readable electronic document data in one container portion might not allow reading the entire container portion or causes unreadable characters. This may inhibit sufficient playback.

The electronic-document-container data file of this embodiment has a function for avoiding the above-described situation. Specifically, when a reading process for the electronic document reader is performed, first, in the case where a plurality of items of electronic document data exist in the container portion, compatibility between respective versions of the electronic document data and a version of the electronic document reader is checked. In the case where data with a version that does not allow accurate playback at the version of the electronic document reader is confirmed among the respective items of electronic document data, a configuration to request a process to a user terminal is considered to be employed. The requested process changes the electronic document data into a version (usually the latest version) that allows accurate playback. In this case, the user terminal receives the request and the process for changing the version is completed. Subsequently, the electronic document data in the container portion is read and displayed.

### Effects

Even in the case where a plurality of items of electronic document data exist in the container portion and the respective items of electronic document data have versions that have difficulty in accurate playback at the version of the electronic document reader, the electronic-document-container data file with this configuration facilitates smooth reading without requesting especially a complicated process to the user.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

This application is based on and claims priority under 35 U.S.C. §119 to Japanese Patent Application No. 2013-041185, filed on Mar. 1, 2013, the entire content of which is incorporated herein by reference.

What is claimed is:

1. An electronic-document-container-data-file generating method for generating a data file using a computer, the data file for being read by a playback program operating on a computer, the data-file generating method comprising steps of:
acquiring at least electronic document data as content data;
generating editable memo data as content data, the memo data being associated with the acquired electronic document data;
generating a container portion configured to hold a plurality of items of content data including the acquired electronic document data and the generated memo data;
generating definition information for defining a method for playing back and/or a method for editing the plurality of items of content data during playback by the playback program; and
generating an electronic-document-container data file including the generated container portion and the generated definition information.

2. The electronic-document-container-data-file generating method according to claim 1, further comprising a step of editing the generated definition information.

3. The electronic-document-container-data-file generating method according to claim 1, wherein the step of generating definition information includes a step of performing an editing-restriction process on the generated definition information.

4. The electronic-document-container-data-file generating method according to claim 1, wherein the step of generating definition information includes a step of holding any one or more items of definition information, the definition information including:
a between-pages interval for automatic playback of the electronic document;
information for specifying, in association with a specified playback page of a one electronic document, a playback page of another electronic document to be played back;
information for specifying, in association with a specified playback page of a one electronic document, a playback area of another moving image in another as content to be played back;
information for specifying, in association with a specified playback page of a one electronic document, a playback area of another sound file in another as content to be played back; and
information for specifying, after a specific playback page of a one electronic document, a playback page of another electronic document to be played back.

5. The electronic-document-container-data-file generating method according to claim 2, wherein the step of generating definition information includes a step of holding any one or more items of definition information, the definition information including:
a between-pages interval for automatic playback of the electronic document;
information for specifying, in association with a specified playback page of a one electronic document, a playback page of another electronic document to be played back;
information for specifying, in association with a specified playback page of a one electronic document, a playback area of a moving image in another as content to be played back;
information for specifying, in association with a specified playback page of a one electronic document, a playback area of a sound file in another as content to be played back; and
information for specifying, after a specific playback page of a one electronic document, a playback page of another electronic document to be played back.

6. The electronic-document-container-data-file generating method according to claim 3, wherein the step of generating definition information includes a step of holding any one or more items of definition information, the definition information including:
a between-pages interval for automatic playback of the electronic document;
information for specifying, in association with a specified playback page of a one electronic document, a playback page of another electronic document to be played back;
information for specifying, in association with a specified playback page of a one electronic document, a playback area of a moving image in another as content to be played back;
information for specifying, in association with a specified playback page of a one electronic document, a playback area of a sound file in another as content to be played back; and
information for specifying, after a specific playback page of a one electronic document, a playback page of another electronic document to be played back.

7. The electronic-document-container-data-file generating method according to claim 1, wherein the step of generating an electronic-document-container data file container portion includes a step of generating a definition-information holding portion configured to hold the definition information.

8. The electronic-document-container-data-file generating method according to claim 1, wherein the container portion is also configured to hold bookmark data for specifying a browsing location within electronic document data.

9. The electronic-document-container-data-file generating method according to claim 1, further comprising a step of generating an index-data holding portion configured to hold index data for searching within the content held in the container portion.

10. The electronic-document-container-data-file generating method according to claim 8, further comprising a step of generating an index-data holding portion configured to hold index data for searching within the content held in the container portion.

11. The electronic-document-container-data-file generating method according to claim 7, wherein the step of generating a definition-information holding portion includes a step of generating a reconfiguration-definition-information holding unit configured to hold definition information for reconfiguring the electronic-document-container data file to be readable by an electronic document reader in a case where the playback program is an electronic document reader.

12. The electronic-document-container-data-file generating method according to claim 1, wherein the container portion includes an editing-restricted electronic-document-data holding unit configured to hold editing-restricted electronic document data as the electronic document data, the editing-restricted electronic document data being electronic document data at least a part of which is editing-restricted.

13. The electronic-document-container-data-file generating method according to claim 8, wherein the container portion includes an editing-restricted electronic-document-data holding unit configured to hold editing-restricted electronic document data as the electronic document data, the editing-restricted electronic document data being electronic document data at least a part of which is editing-restricted.

14. The electronic-document-container-data-file generating method according to claim 9, wherein the container portion includes an editing-restricted electronic-document-data holding unit configured to hold editing-restricted electronic document data as the electronic document data, the editing-restricted electronic document data being electronic document data at least a part of which is editing-restricted.

15. The electronic-document-container-data-file generating method according to claim 10, wherein the container portion includes an editing-restricted electronic-document-data holding unit configured to hold editing-restricted electronic document data as the electronic document data, the editing-restricted electronic document data being electronic document data at least a part of which is editing-restricted.

16. An electronic-document-container-data-file generating device for generating a data file using a computer, the data file for being read by a playback program operating on a computer, the data file-generating device comprising:
an electronic-document-data acquiring unit configured to acquire at least electronic document data as content data;
a memo-data generating unit configured to generate editable memo data as content data, the memo data being associated with the acquired electronic document data;
a container-portion generating unit configured to generate a container portion, the container portion being configured to hold a plurality of items of content data including the acquired electronic document data and the generated memo data;
a definition-information generating unit configured to generate definition information for defining a method for playing back and/or a method for editing the plurality of items of content data during playback by the playback program; and
an electronic-document-container-data-file generating unit configured to generate an electronic-document-container data file including the generated container portion and the generated definition information.

17. A computer program product comprising a computer readable storage medium having computer readable program code embodied in the medium for generating a data file using a computer, the data file for being read by a playback program operating on a computer, the computer readable program code for causing a computer to execute a process comprising steps of:
acquiring at least electronic document data as content data;
generating editable memo data as content data, the memo data being associated with the acquired electronic document data;
generating a container portion, the container portion being configured to hold a plurality of items of content data including the acquired electronic document data and the generated memo data;
generating definition information for defining a method for playing back and/or a method for editing the plurality of items of content data during playback by the playback program; and
generating an electronic-document-container data file including the generated container portion and the generated definition information.

18. A server device comprising the computer readable program code according to claim 17, deliverable on a network.
